(19) United States
(12) Patent Application Publication
(10) Pub. No.: US 2014/0134424 A1
(43) Pub. Date: May 15, 2014

(54) COMPOSITE BOARD

(71) Applicant: KUEI HAO HSU, TAINAN CITY (TW)

(72) Inventor: KUEI HAO HSU, TAINAN CITY (TW)

(21) Appl. No.: 13/677,515

(22) Filed: Nov. 15, 2012

(51) Int. Cl. B32B 27/08; B32B 5/18; B32B 27/06

(52) U.S. Cl. CPC B32B 27/08; B32B 27/065; B32B 5/18
USPC 428/319.9; 428/518; 428/516; 428/494

(57) ABSTRACT

A composite board includes a polystyrene board having a first side, and a first tough board is bonded to the first side of the polystyrene board. The first tough board is preferably made of a material selected from the group consisting of ethylene vinyl acetate copolymer (EVA), polyethylene vinyl acetate (PEVA), polyethylene (PE), plastic foam, and rubber. The composite board can further include a second tough board bonded to a second side of the polystyrene board opposite to the first side.

### BACKGROUND OF THE INVENTION

The present invention relates to a composite board and, more particularly, to a composite board including a tough board bonded to at least one side of a polystyrene board.

Various woods are used as structural or decorative boards. Plywood is generally comprised of wood dusts. However, water and moisture are liable to permeate into the gaps between the wood dusts, leading to decay of the plywood as well as peeling of an outer layer bonded to the plywood. Solid wooden boards are expensive due to shortage and are heavy and require complicated processing. Furthermore, quality control is not easy for various wooden boards with different properties. Plaster boards or calcium silicate boards are used for fire resisting purposes. However, the plaster boards and calcium silicate boards are fragile and liable to moisten.

Thus, a need exists for a novel board for construction purposes.

### BRIEF SUMMARY OF THE INVENTION

A composite board according to the present invention includes a polystyrene board having a first side, and a first tough board is bonded to the first side of the polystyrene board.

The first tough board is preferably made of a material selected from the group consisting of ethylene vinyl acetate copolymer (EVA), polyethylene vinyl acetate (PEVA), polyethylene (PE), plastic foam, and rubber.

The composite board can further include a second tough board bonded to a second side of the polystyrene board opposite to the first side.

The second tough board is preferably made of a material selected from the group consisting of ethylene vinyl acetate copolymer (EVA), polyethylene vinyl acetate (PEVA), polyethylene (PE), plastic foam, and rubber.

The composite board according to the present invention provides an excellent buffering effect while the composite board is under a load. Furthermore, the composite board including the polystyrene board 1 and the first tough board 2 provides a thermally insulating effect, increasing the cooling room effect for an air conditioner and saving the energy. Further, composite board possesses a temperature maintaining effect while using hot air, saving the energy by providing an insulating effect to the hot air. Further, the composite board avoids moths and, thus, prolongs the service life. Further, the composite board provides an excellent soundproof effect and, thus, can effectively avoid noise when used as a wall. Further, the composite board is light, and the weight of the composite board can less than 10% of the weight of a board made of wood or stone having the same size. Further, the composite board is without formaldehyde and is, thus, eco-friendly, healthy, and energy-saving.

The present invention will become clearer in light of the following detailed description of illustrative embodiments of this invention described in connection with the drawings.

### DESCRIPTION OF THE DRAWINGS

FIG. 1 shows a perspective view of a composite board of a first example according to the present invention.

FIG. 2 shows a perspective view of a composite board of a second example according to the present invention.

FIG. 3 shows an exploded, perspective view of the composite board of FIG. 2.

FIG. 4 shows a perspective view illustrating stacking of two composite boards.

### DETAILED DESCRIPTION OF THE INVENTION

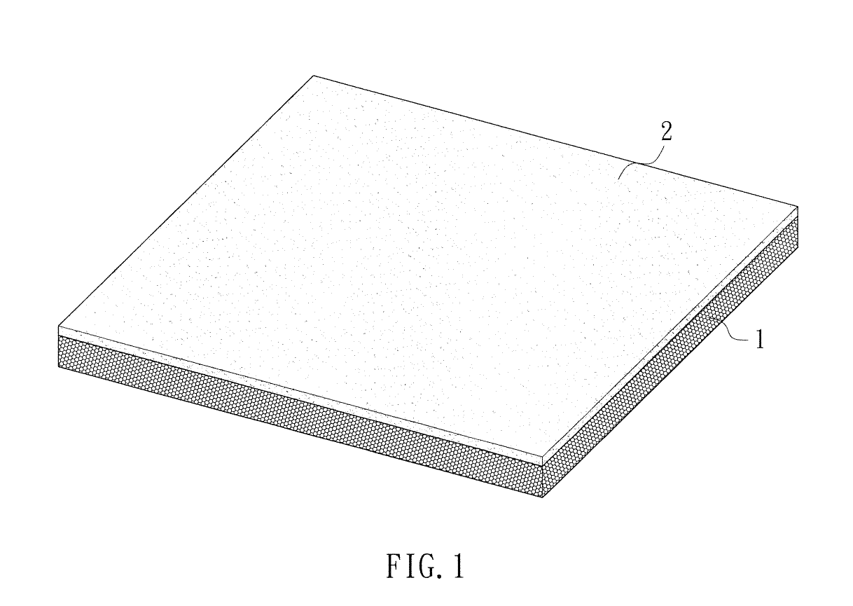

With reference to FIG. 1, a composite board according to the present invention includes a polystyrene (PS) board 1 having a first side and a second side opposite to the first side. A first tough board 2 is bonded to the first side of the polystyrene board 1 that serves as a substrate.

A foaming agent can be added into the polystyrene board I according to needs. If a foaming agent is added to form a light structure, the resultant polystyrene board 1 has improved thermal insulation. The polystyrene board I can be produced by injection molding, pressing, extrusion, or heating.

The first tough board 2 is made of a material selected from the group consisting of ethylene vinyl acetate copolymer (EVA), polyethylene vinyl acetate (PEVA), polyethylene (PE), plastic foam, and rubber. EVA has excellent toughness and elasticity and has good flexibility at low temperature. Furthermore, EVA is stable and can be easily colored and shaped. PEVA is a combination of low density polyethylene and EVA and, thus, are elastic, cold resistant, and eco-friendly. All of PE, plastic foam, and rubber include toughness.

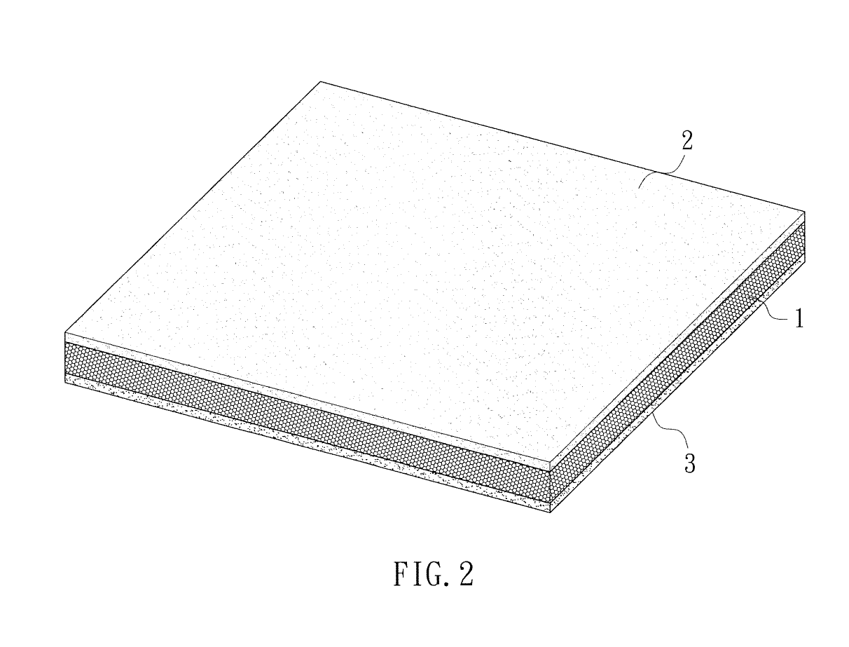

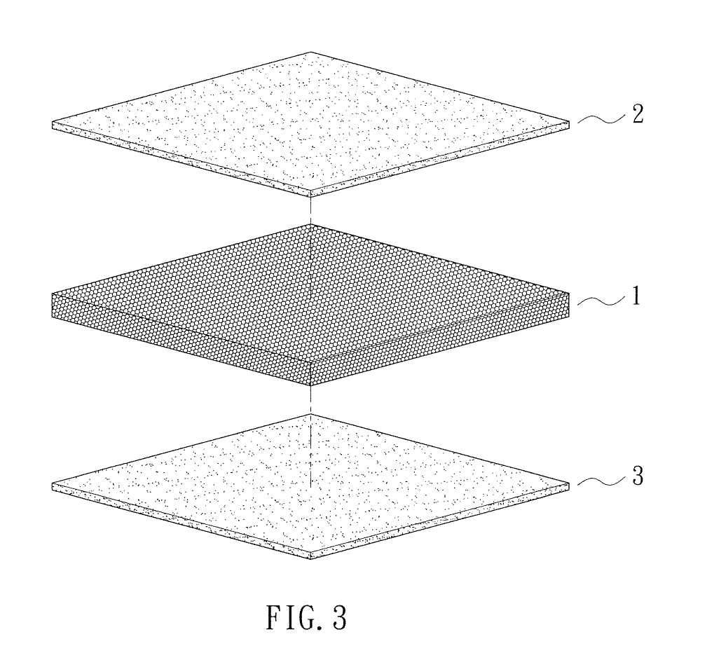

With reference to FIGS. 2 and 3, a second tough board 3 can be bonded to the second side of the polystyrene board 1. The second tough board 3 is made of a material selected from the group consisting of ethylene vinyl acetate copolymer (EVA), polyethylene vinyl acetate (PEVA), polyethylene (PE), plastic foam, and rubber.

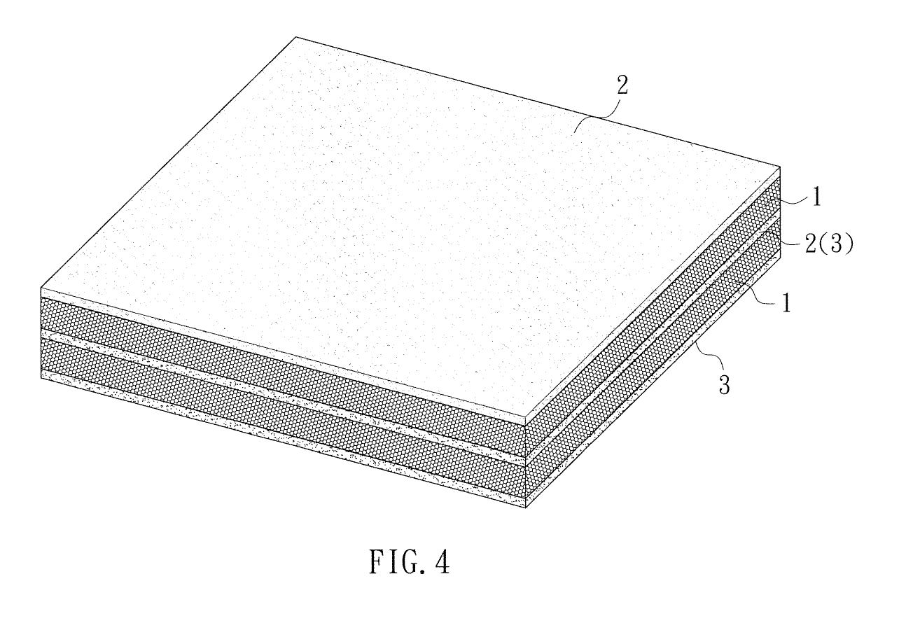

With reference to FIG. 4, the polystyrene board 1 and the first and second tough boards 2 and 3 can be stacked as many as desired. In the example shown, a first tough board 2, a polystyrene board 1, a first or second tough board 2, 3, another polystyrene board 1, and a second tough board 3 are stacked in sequence.

The composite board according to the present invention provides an excellent buffering effect while the composite board is under a load. Furthermore, the composite board including the polystyrene board 1 and the first tough board 2 provides a thermally insulating effect, increasing the cooling room effect for an air conditioner and saving the energy. Further, composite board possesses a temperature maintaining effect while using hot air, saving the energy by providing an insulating effect to the hot air. Further, the composite board avoids moths and, thus, prolongs the service life. Further, the composite board provides an excellent soundproof effect and, thus, can effectively avoid noise when used as a wall. Further, the composite board is light, and the weight of the composite board can less than 10% of the weight of a board made of wood or stone having the same size. Further, the composite board is without formaldehyde and is, thus, eco-friendly, healthy, and energy-saving.

Although specific embodiments have been illustrated and described, numerous modifications and variations are still possible without departing from the essence of the invention. The scope of the invention is limited by the accompanying claims.

1. A composite board comprising a polystyrene board having a first side; and a first tough board bonded to the first side of the polystyrene board.

2. The composite board as claimed in claim 1, wherein the first tough board is made of a material selected from the group consisting of ethylene vinyl acetate copolymer (EVA), polyethylene vinyl acetate (PEVA), polyethylene (PE), plastic foam, and rubber.

3. The composite board as claimed in claim 1, with the polystyrene board further having a second side opposite to the first side, with a second tough board bonded to the second side of the polystyrene board.

4. The composite board as claimed in claim 3, wherein the second tough board is made of a material selected from the group consisting of ethylene vinyl acetate copolymer (EVA), polyethylene vinyl acetate (PEVA), polyethylene (PE), plastic foam, and rubber.
